(19) United States
(12) Patent Application Publication
(10) Pub. No.: US 2026/0242576 A1
(43) Pub. Date: Aug. 20, 2026

(54) PROCESSES FOR PRODUCING UPGRADED POST-CONSUMER RECYCLED POLYETHYLENE

(71) Applicant: Dow Global Technologies LLC, Midland, MI (US)

(72) Inventors: Amit K. Chaudhary, Missouri City, TX (US); Qi Chen, Sugar Land, TX (US)

(73) Assignee: Dow Global Technologies LLC, Midland, MI (US)

(21) Appl. No.: 19/161,832

(22) PCT Filed: Feb. 22, 2024
(86) PCT No.: PCT/US2024/016875

§ 371 Date: Sep. 3, 2025

Related U.S. Application Data
(60) Provisional application No. 63/488,873, filed on Mar. 7, 2023.

(51) Int. Cl. C08L 23/06; C08J 3/20

(52) U.S. Cl. CPC C08L 23/06; C08J 3/201; C08J 2323/06; C08J 2423/06; C08L 2205/02; C08L 2207/066; C08L 2207/20

(57) ABSTRACT

Embodiments of processes for producing upgraded post-consumer recycled polyethylene (PCR PE) may include melt blending non-pelletized PCR PE with virgin polyethylene in an extruder to produce a PCR/virgin blend, and melt filtering the PCR/virgin blend to remove contaminants and produce the upgraded PCR PE.

### CROSS-REFERENCE TO RELATED APPLICATIONS

This application claims the benefit of U.S. Provisional Application Ser. No. 63/488,873 filed Mar. 7, 2023, the contents of which are incorporated in their entirety herein.

### TECHNICAL FIELD

The present disclosure generally relates to processes for producing upgraded post-consumer recycled polyethylene, and specifically relates to processes for producing upgraded post-consumer recycled polyethylene comprising melt blending and melt filtering a non-pelletized post-consumer recycled polyethylene and virgin polyethylene.

### BACKGROUND

Plastic waste is one of the most important sustainability issues of the twenty-first century. Each year, nearly 400 million tons of plastic waste is produced globally. However, only an estimated 9% of plastic is recycled. Plastic that is not recycled may either end up in a landfill, may be incinerated, or may become litter. In a landfill, plastic can hundreds of years to decompose. Incinerated plastic can pose environmental and health dangers by releasing toxic cases, heavy metals, and particles into the air. Finally, plastic litter can pose danger to wildlife, especially when it finds its way into oceans and streams.

Although conventional recycling processes can prevent plastics from ending up in landfills, being incinerated, or becoming litter, many recycling processes can be expensive or inefficient. Additionally, conventionally recycling processes subject recycled plastic to multiple heating and cooling steps which may degrade the recycled plastic and make the recycled plastic less durable. Accordingly, a need exists for recycling processes that streamline recycling, minimize the number of times that the recycled plastic is heated, and make the recycling process more energy efficient and environmentally friendly.

### SUMMARY

Embodiments of the present disclosure address these and other needs by providing processes for producing upgraded post-consumer recycled polyethylene (PCR PE). The processes may comprise melt blending non-pelletized PCR PE with virgin polyethylene in an extruder to produce a PCR/virgin blend. The processes may further comprise melt filtering the PCR/virgin blend to remove contaminants and produce the upgraded PCR PE.

Additional features and advantages will be set forth in the detailed description that follows and, in part, will be readily apparent to those skilled in the art from that description or recognized by practicing the embodiments described herein, including the detailed description which follows in addition to the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 shows an overview of a conventional process for producing upgraded post-consumer recycled polyethylene (PCR PE).

FIG. 2 shows an overview of an example process for producing upgraded PCR PE according to examples described herein.

### DETAILED DESCRIPTION

Reference will now be made in detail to examples of processes for producing upgraded post-consumer recycled polyethylene (PCR PE). In examples described herein, the processes for producing upgraded PCR PE may comprise melt blending non-pelletized PCR PE with virgin polyethylene in an extruder to produce a PCR/virgin blend. The processes may also comprise melt filtering the PCR/virgin blend to remove contaminants and produce the upgraded PCR PE.

As used in this disclosure, the terms “blend”, “polymer blend”, and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

As used in this disclosure, the term “melt blending” refers to a process where two or more polymers are heated and mixed to form a polymer blend. Melt blending may occur using a single screw extruder, a twin screw extruder, a Banbury mixer, or using other techniques known to those of skill in the art.

As used in this disclosure, the term “melt filtering” refers to a process where contaminant plastic particle such as cross-linked plastics, degraded plastics, or gels, as well as non-plastic particles, such as wood, glass, aluminum, paper, or sand, are removed from melted plastic by filtering the melted plastic.

As used in this disclosure, the term “polyethylene” or “ethylene-based polymer” refers to polymers comprising greater than 50% by mole of units which have been derived from ethylene monomer. This includes polyethylene homopolymers or copolymers (meaning units derived from two or more comonomers), or blends thereof. The polymers may be resins. Common forms of ethylene-based polymer known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

As used in this disclosure, the term “virgin polyethylene” refers to material or blend of polyethylene resins as listed above that has not undergone any additional processing or use after its manufacture. For example, virgin polyethylene may refer to manufactured polyethylene that is ready for further processing, but has not undergone any processing other than the processing needed to form the polyethylene.

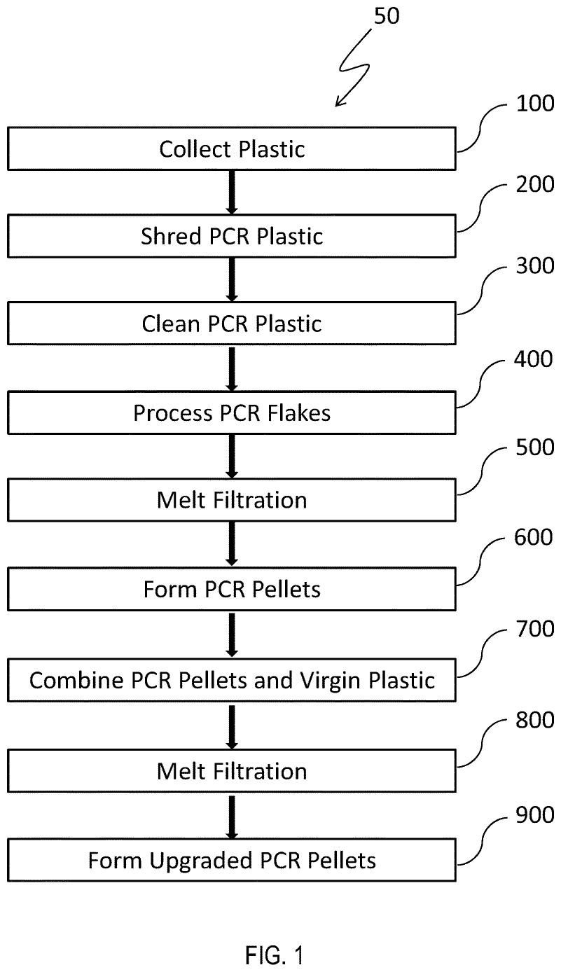

FIG. 1 shows an overview of a typical recycling process. The process 50 usually begins by collecting plastic 100. The plastic may be collected directly from consumers, businesses, or the like though recycling programs or other means, or may be obtained indirectly from waste management companies, recycling centers, or the like. The post consumer recycled (PCR) plastic is then shredded 200 to produce PCR flakes. The PCR flakes may vary in size and shape. The PCR flakes may undergo sorting to remove contaminates, unwanted plastic types, unwanted plastic colors, and other unwanted materials (not shown). The PCR flakes are then cleaned 300 to remove contaminants including glues, oils, greases, dirt, paper, food residue, or beverage residue. The cleaning may comprise washing and drying the PCR plastic.

The PCR flakes may then be further processed 400. This processing includes melting and mixing the PCR flakes in an extruder or another processing unit. Many plastics, including both high density polyethylene and low density polyethylene possess definite microstructures that arise from the repeated folding of molecular chains. Melting these plastics can disrupt the repeated folding of the molecular chains, which damages and degrades the microstructure of the plastic. Melting these plastics may also cause contaminants in the plastics to combust and leave behind residue that discolors the plastics. Additionally, melting, homogenizing, and pelletizing the plastic requires significant energy, often as much as from 0.14 kilowatt hours per kilogram of plastic (kWh/kg) to 0.31 kWh/kg.

After the PCR flakes are heated and mixed during processing, resulting compound may then be melt filtered 500 to remove contaminants. After melt filtering, the resulting compound may then be shaped into pellets 600 or other compact forms. To shape the resulting compound into pellets, the resulting compound is passed through a die, and simultaneously cooled and cut into pellets. The PCR pellets are typically then transported to a compounder, where the PCR pellets are again heated and combined with virgin plastic 700. Again, this melting damages the microstructure of the plastics and causes additional discoloration, as contaminants in the PCR pellets that did not previously combust may now combust and leave behind additional residue. The PCR/virgin blend is then melt filtered 800 to produce an upgraded PCR plastic. The upgraded PCR plastic is then shaped into pellets 900 or another compact form. The upgraded PCR pellets may then be transported and used to fabricate goods made with recycled plastic.

Although this conventional recycling process helps keep plastic out of landfill, prevents environmental contamination from incinerating plastics, and protects wildlife and waterways, this conventional process consumes unnecessary energy and weakens the PCR plastic by heating and cooling it multiple times. Processes described herein streamline the PCR plastic recycling process by eliminating unnecessary heating and cooling which protects the microstructure of the PCR plastic and saves energy in the recycling process.

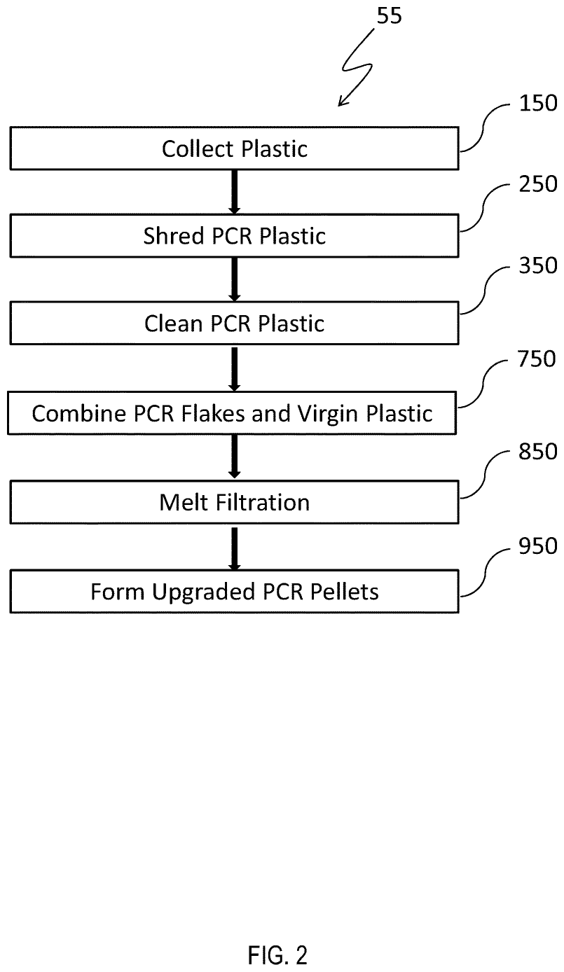

Referring now to FIG. 2, an embodiment according to the present disclosure is depicted. As with conventional recycling processes, the process 55 begins with collecting plastic 150. Again, the PCR plastic is cleaned 250 and shredded 350 to produce PCR flakes. Again, the PCR flakes may be baled if desired for transport (not shown). However, unlike conventional recycling processes, the PCR flakes alone are not processed and melt filtered, which save significant energy. Instead the PCR flakes are heated and combined with virgin polyethylene 750. The resulting compound may then be melt filtered 850 and the upgraded PCR plastic may be shaped into pellets 950 or another compact form.

In some examples, a process for producing upgraded post-consumer recycled (PCR) plastic comprises melt blending non-pelletized PCR plastic with virgin plastic in an extruder to produce a PCR/virgin blend. The process may further comprise melt filtering the PCR/virgin blend to remove contaminants and produce an upgraded PCR plastic.

The PCR plastic may be PCR polyethylene (PCR PE). Polyethylene is commonly used in the in disposable plastic bottles, disposable condiment containers, milk jugs, shopping bags, trash bags, soap dispensers, yogurt tubs, frozen meals, furniture, and many other household objects. The virgin plastic may be virgin polyethylene. As the stated above, polyethylene may include LDPE, LLDPE, MDPE, HDPE, and blends thereof. Consequently, PCR PE also may include LDPE, LLDPE, MDPE, HDPE, and blends thereof.

In some examples, the PCR plastic may be processed to separate out certain types of plastics. For instance, the PCR plastic might be passed through a sink float separation tank that separates polyethylene terephthalate (PET) plastics, polypropylene (PP) plastics, and polyethylene (PE) plastics based on density.

The non-pelletized PCR PE is PCR PE that has not undergone any melting. The non-pelletized PCR PE may be in the form of flakes. Once the PCR PE is gathered from consumers, the PCR PE may be cut, shredded, or processed by other means known to the person of ordinary skill in the art to produce flakes. The flakes may vary significantly in size and shape. If compacting the flakes for transportation is desired, the flakes may be gathered into bales.

The non-pelletized PCR PE may be washed to remove contaminates such as glues, oils, greases, dirt, paper, food residue, or beverage residue. Such washing may be performed by passing PCR PE flakes through a water bath, spraying the PCR PE flakes with water, passing the PCR PE flakes over a mesh screen to remove contaminants, rubbing the PCR PE flakes against each other, or combinations thereof. The non-pelletized PCR PE may also be dried. Such drying may be performed by using centrifugal force to remove water from the PCR flakes, by thermally drying the PCR flakes, or combinations thereof.

Although washing decreases the number of contaminants present in the PCR PE, it seldom eliminates all of the contaminants. Some of the remaining contaminants in the PCR PE may combust when the PCR PE is heated during processing and pelletization. This combustion often leaves behind residue that discolors the PCR PE. Every melting that the PCR PE undergoes may cause additional contaminants to combust, and may cause additional discoloration to the PCR PE. Thus, each additional melting of the PCR PE may result in greater discoloration of the PCR PE. Therefore, processes that eliminate melting, such as the melting present during processing and pelletization, may produce PCR PE and PCR PE blends that have less discoloration. Although pelletizing the PCR PE before combining the PCR PE with virgin polyethylene may be conventional, such processing and pelletization damages the microstructure of the PCR PE and causes additional discoloration while providing little benefit.

In some examples, melt blending the non-pelletized PCR PE and the virgin polyethylene may take place in an extruder. The extruder may be a single screw extruder or a double screw extruder. The single screw extruder may be operated at a processing temperature from 180° C. to 265° C., from 200° C. to 265° C., from 225° C. to 265° C., from 180° C. to 250° C., or from 180° C. to 225° C. and a screw speed of from 150 revolutions per minute (rpm) to 250 rpm, from 175 rpm to 250 rpm, from 200 rpm to 250 rpm, from 150 rpm to 225 rpm, or from 150 rpm to 200 rpm. The twin screw extruder may be operated at a processing temperature from 180° C. to 265° C., from 200° C. to 265° C., from 225° C. to 265° C., from 180° C. to 250° C., or from 180° C. to 225° C. and a screw speed of from 200 revolutions per minute (rpm) to 450 rpm, from 250 rpm to 450 rpm, from 300 rpm to 450 rpm, from 250 rpm to 400 rpm, or from 250 rpm to 350 rpm. The extruder, for a given size, may operate at a rate of from 500 pounds per hour (lb/h) to 1000 lb/h, from 600 lb/h to 1000 lb/h, from 700 lb/h to 1000 lb/h, from 500 lb/h to 900 lb/h, or from 750 lb/h to 850 lb/h.

Without being bound by theory, it is believed that melt blending the PCR PE with virgin polyethylene may enhance the strength and durability of the upgraded PCR PE. In some examples, the PCR PE may be melt blended with a virgin polyethylene having the same density as the density of the PCR PE. In some examples, the PCR PE may be melt blended with a virgin polyethylene having a density that is either higher or lower than the density of the PCR PE. In some examples, melt blending involves homogenization of the PCR PE and the virgin polyethylene. Although melt blending mixes the PCR PE and the virgin polyethylene, the PCR PE and the virgin polyethylene are only homogenized if they are evenly spread throughout the resulting PCR/virgin blend. Thus, in examples where the PCR PE and the virgin polyethylene are homogenized, the PCR PE and the virgin polyethylene are evenly spread through the melt blend.

The non-pelletized PCR PE may have a density of from 0.870 grams per cubic centimeter (g/cc) to 0.965 g/cc, from 0.880 g/cc to 0.955 g/cc, or from 0.890 g/cc to 0.945 g/cc, from 0.900 g/cc to 0.945 g/cc, from 0.910 g/cc to 0.930 g/cc, from 0.915 g/cc to 0.925 g/cc, or from 0.918 g/cc to 0.922 g/cc.

The non-pelletized PCR PE may comprise a melt index (I₂) of from 0.3 g/10 mins to 5.0 g/10 mins, 0.5 g/10 mins to 2.0 g/10 mins, from 0.25 g/10 mins to 5.0 g/10 mins, from 0.1 g/10 mins to 10 g/10 mins, from 0.75 g/10 mins to 1.75 g/10 mins, or from 1.0 g/10 mins to 1.5 g/10 mins.

The virgin polyethylene may have a density of from 0.870 grams per cubic centimeter (g/cc) to 0.965 g/cc, from 0.880 g/cc to 0.955 g/cc, or from 0.890 g/cc to 0.945 g/cc. In some examples, the virgin polyethylene may comprise a low density polyethylene (LDPE) having a density of from 0.900 g/cc to 0.945 g/cc, from 0.910 g/cc to 0.930 g/cc, from 0.915 g/cc to 0.925 g/cc, or from 0.918 g/cc to 0.922 g/cc.

The non-pelletized PCR PE may be obtained from a variety of sources. The non-pelletized PCR PE may comprise post-consumer recycled material derived from monolayer flexible films, multilayer flexible films, and combinations thereof. The monolayer flexible films and the multilayer flexible films may have a thickness of less than or equal to 10 mils.

In one embodiment, the upgraded PCR PE does not undergo additional compounding steps downstream of the melt filtering. Conventional recycling processes often melt filter PCR PE flakes after they have been processed. The melt filtered PCR PE is then shaped into pellets and then the pellets are combined with virgin polyethylene which then undergoes additional melt filtration. However, the processes described herein do not subject the PCR PE to any melting before the PCR PE is combined with virgin polyethylene. After the PCR PE has been combined with the virgin polyethylene and has been melt filtered, no additional compounding steps are needed. In some examples, melt filtering occurs downstream of homogenization. Although conventional recycling processes often subject PCR PE flakes to melt filtering before the PCR PE is melt blended with virgin polyethylene, the present eliminate any melting of the PCR flakes prior to blending with the virgin polyethylene. While melt filtering helps to remove contaminants, melt filtering may weaken the microstructure of the PCR PE and may cause additional discoloration due to contaminant combustion because melt filtering requires that the PCR PE to be heated. By melt filtering the PCR/virgin blend after it has been homogenized, the PCR PE may be subjected to fewer melt filtering steps, which may lessen the damage to the upgraded PCR PE microstructure and may lessen the amount of discoloration of the upgraded PCR PE.

Melt filtering may involve at least one, or at least two filtration steps. The filtration steps may include passing heated plastic through a laser filter (continuous filtration technique where the screen is made by drilling precision holes using laser beam and a collected contaminant is continuously scraped and removed without the need of removal of the filter screen), a surface filter (eg, mesh filter, a woven screen filter etc), depth filter (sintered powder filter, a super pate filter, a random fiber filter, etc), combinations thereof, or other types of filters known in the art. Each filtration step may employ the same filters in each step, or may employ different filters in each filtration step. In some examples, multiple melt filtration steps may comprise only melting the plastic to be filtered once, and then performing multiple filtration steps with the melted plastic.

In some examples, a first melt filtering step may comprise passing the plastic through a first filter having a screen aperture size of from 50 μm to 250 μm, from 70 μm to 200 μm, from 75 μm to 175 μm, from 80 μm to 150 μm, or from 80 μm to 120 μm. In some examples, a second melt filtering step may comprise passing the plastic through a second filter located downstream of the first filter. The second filter may have a screen aperture size of from 10 μm to 300 μm, from 25 μm to 250 μm, from 35 μm to 200 μm, from 40 μm to 150 μm, or from 50 to 100 μm.

The upgraded PCR PE may comprise additional additives. In some examples, the additional additives may be added when the non-pelletized PCR PE is melt blended with the virgin polyethylene. These additional additives may impart additional strength and durability to the upgraded PCR PE. In some examples, these additives may include antioxidant packages, slips, fillers, polymer processing aids, coupling agents, odor absorbing agents, fire retardants, or dyes. The antioxidant packages may include primary antioxidants, secondary antioxidants, or combinations thereof. The antioxidant packages may include hindered phenols, phosphites, thioethers, aromatic amines, hydroxylamines, or combinations thereof. The fillers may include calcium carbonate, talc, or combinations thereof. The slips may include amides. The coupling agents may include silanes, maleic anhydride grafted polymers, stearates, organotitanates, or combinations thereof. The dyes may include organic dyes, titanium oxide, carbon black, or combinations thereof. The polymer processing aids may include fluoro polymers.

### Upgraded PCR PE

In one or more embodiments, an upgraded PCR PE may be produced from the non-pelletized PCR PE and virgin polyethylene described herein. The upgraded PCR PE may be used in pellets, resins, or films, for example, monolayer or multilayer films. The upgraded PCR PE, which incorporates film may be used in non-rigid packages, such as trash bags, shopping bags, flexible packages, pouches, stand-up pouches, and the like. The upgraded PCR PE may also be used in rigid packages, for example, trash cans, compost bins, plastic bottles, condiment containers, milk jugs, soap dispensers, yogurt tubs, frozen meals, and the like. The upgraded PCR PE may also be used in furniture, paneling, lumber, landscaping ties, floor tile, and the like.

The upgraded PCR PE may have a density of from 0.876 g/cc to 0.961 g/cc, from 0.880 g/cc to 0.955 g/cc, from 0.885 g/cc to 0.950 g/cc, from 0.888 g/cc to 0.945 g/cc, or from 0.902 g/cc to 0.942 g/cc.

The upgraded PCR PE may comprise from 1% to 99% virgin polyethylene, from 10% to 90% virgin polyethylene, from 20% to 80% virgin polyethylene, from 25% to 75% or from 30% to 60% virgin polyethylene. The amount of virgin polyethylene used may affect the color, durability, and level of contamination of the upgraded PCR PE.

### Test Methods

Melt Index (190° C., 2.16 kg, “I₂”) Test Method: ASTM D 1238-13, Standard Test Method for Melt Flow Rates of Thermoplastics by Extrusion Plastometer, using conditions of 190° C./2.16 kilograms (kg), the entire protocol of which is hereby incorporated by reference. Results are reported in units of grams eluted per 10 minutes (g/10 min.)

Density measurements were performed according to ASTM D4703, the entire protocol of which is hereby incorporated by reference. Measurements were made, according to ASTM D792, Method B, within one hour of sample pressing, the entire protocol of which is hereby incorporated by reference.

Discoloration measurements were performed by assessing Yellowness Index according to ASTM D6290, the entire protocol of which is hereby incorporated by reference.

Number average molecular weight (MW) may be determined according to ASTM D4274, the entire protocol of which is hereby incorporated by reference.

### EXAMPLES

The following Examples are offered by way of illustration and are presented in a manner such that one skilled in the art should recognize are not meant to be limiting to the present disclosure as a whole or to the appended claims.

### Example 1

Washed post-consumer recycled polyethylene (PCR PE) AVG 150 flakes, having a melt index I₂ of 0.6736-0.9521 g/10 min and a density of 0.921-0.933 g/cm³, commercially available from Avangard Innovative, were fed into a pre-conditioning unit with virgin low density polyethylene (LDPE) 132I pellets, commercially available from Dow Inc, Midland, MI in a single screw extruder INTAREMA 1108TVE plus equipped with two inline filtration system, an Erema laser filter, and an Erema backflush filter, commercially available from Erema. The PCR PE flakes and the virgin LDPE pellets were then melt blended in the single screw extruder to produce a homogenized blend. The extruder had a throughput rate of 943 pounds per hour (lbs/h), a screw speed of 190 revolutions per minute (rpm), a torque of 91%, and a melt pressure at die of 764 pound per square inch (psi). The PCR PE flakes comprised 70% by weight of the homogenized blend and the virgin LDPE pellets comprised 30% by weight of the homogenized blend. The process included two melt filtration unit operations to remove contaminants. The melt temperature before prefilter was 402° F. The melt pressure before filter was 2311 psi. The homogenized blend was first passed through a laser filter perfilter that screened for contaminates from 90 micrometers (μm) to 110 μm or greater. The homogenized blend was then passed through a fine filter that screened for contaminants greater than 50 μm. The upgraded PCR PE was shaped into a pellet by passing the upgraded PCR PE through a die followed by simultaneous water cooling and cutting the upgraded PCR PE into pellets.

### Comparative Example 2

Washed post-consumer recycled polyethylene (PCR PE) AVG 150 flakes, having a melt index I₂ of 0.6736-0.9521 g/10 min and a density of 0.921-0.933 g/cm³, commercially available from Avangard Innovative, were melt blended in a single screw extruder INTAREMA 1108TVE plus equipped with two inline filtration system, an Erema laser filter, and an Erema backflush filter, commercially available from Erema to produce PCR PE pellets. The extruder had a throughput rate of 900 lbs/h, a screw speed of 190 rpm, a torque of 92%, and a melt pressure at die of 645 psi. The PCR PE was then melt filtered. The melt temperature before prefilter was 397° F. The melt pressure before filter was 2049 psi. The PCR PE was first passed through a perfilter that screened for contaminates from 90 micrometers (μm) to 110 μm or greater. The PCR PE was then passed through a fine filter that screened for contaminants greater than 50 μm. The resulting PCR PE was shaped into a pellet by passing the PCR PE through a die followed by simultaneous water cooling and cutting the PCR PE into pellets. The PCR PE pellets were then compounded with virgin low density polyethylene (LDPE) 132I pellets, commercially available from Dow Chemical in a separate mixer using a 40 mm Coperion twin screw extruder. The PCR PE pellets comprised 70% by weight of the resulting compound and the virgin LDPE pellets comprised 30% by weight of the resulting compound. The extruder had a throughput rate of 200 lbs/h, a screw speed of 250 rpm, and a melt pressure at die of 1503 psi. The PCR/virgin blend then underwent melt filtering. The melt pressure before filter was 2375 psi. The PCR/virgin blend was passed through a filter that screened for contaminants greater than 149 μm. The resulting upgraded PCR PE was shaped into a pellet by passing the upgraded PCR PE through a die followed by simultaneous water cooling and cutting the upgraded PCR PE into pellets.

### Comparative Examples 3-5

Washed post-consumer recycled polyethylene (PCR PE) AVG 150 flakes, having a melt index I₂ of 0.6736-0.9521 g/10 min and a density of 0.921-0.933 g/cm³, commercially available from Avangard Innovative, were melt blended in a single screw extruder INTAREMA 1108TVE plus equipped with two inline filtration system, an Erema laser filter, and an Erema backflush filter, commercially available from Erema to produce PCR PE pellets. The extruder had a throughput rate of 900 lbs/h, a screw speed of 190 rpm, a torque of 92%, and a melt pressure at die of 645 psi. The PCR PE was then melt filtered. The melt temperature before prefilter was 397° F. The melt pressure before filter was 2049 psi. The PCR PE was first passed through a perfilter that screened for contaminates from 90 micrometers (μm) to 110 μm or greater. The PCR PE was then passed through a fine filter that screened for contaminants greater than 50 μm. The resulting PCR PE was shaped into a pellet by passing the PCR PE through a die followed by simultaneous water cooling and cutting the PCR PE into pellets. The PCR PE pellets were then compounded with virgin low density polyethylene (LDPE) 132I pellets, commercially available from Dow Chemical in a separate Banbury mixer equipped with a single screw extruder. The Banbury mixer was operated with a batch size of from 390-420 lbs, a mixing time of from 65 second to 150 seconds, and a drop temperature of from 145° C. and 150° C. The single screw extruder had a process temperature of from 180° C. and 240° C. and an extruder speed of from 25 rpm to 50 rpm. The PCR PE pellets comprised 70% by weight of the resulting compound and the virgin LDPE pellets comprised 30% by weight of the resulting compound. The resulting upgraded PCR PE was shaped into a pellet by passing the upgraded PCR PE through a die followed by simultaneous water cooling and cutting the upgraded PCR PE into pellets.

The properties of the resulting pellets in Examples 1-5 are as shown in Table 1 and Table 2.

TABLE 1
Pellet Properties

| Property | | Results | | | | |
|---|---|---|---|---|---|---|
| Example | | Inven. | Comp. | Comp. | Comp. | Comp. |
| Number | Units | 1 | 2 | 3 | 4 | 5 |
| Gels | (GI200) | 785.59 | 746.54 | 740.4 | 759.5 | 933.9 |
| Yellowness | | 22.03 | | 32.88 | 32.46 | 32.63 |
| Index | | | | | | |
| Ash Content | (%) | 0.75 | 0.82 | 0.77 | 0.78 | 0.81 |
| Irganox 1010 | ppm | 20 | 14 | 15 | 16 | |

TABLE 2
Comparative Differences

| | | Results | | |
|---|---|---|---|---|
| | | Example | | Percent |
| Property | Units | Inven. 1 | Comp. 3 | Difference |
| Avg Clarity | (%) | 90.42 | 88.34 | 2.35 |
| Gloss | | 60.58 | 59.12 | 2.47 |
| Avg Shrinkage MD | (%) | 81.30 | 78.80 | 3.17 |
| Tear-Estimated | gf | 1176.85 | 1203.53 | −2.22 |
| Elmendorf CD | | | | |
| Shrink Force | mN | 80.50 | 83.23 | −3.28 |
| Shrink Stress | MPa | 0.09 | 0.10 | −9.32 |
| Energy to Break CD | in · lbf | 65.92 | 69.63 | −5.33 |
| Peak Load CD | lbf | 8.30 | 8.55 | −2.96 |
| Tensile-Strain at | % | 663.57 | 709.37 | −6.46 |
| Break CD | | | | |
| Strain at yield CD | % | 7.73 | 8.06 | −4.06 |
| Stress at Yield CD | psi | 2005.78 | 2246.79 | −10.73 |
| Peak Load MD | lbf | 6.51 | 7.29 | −10.74 |
| Secant 1% MD | psi | 64449.93 | 68067.41 | −5.31 |
| Secant 2% MD | psi | 54851.54 | 58645.71 | −6.47 |
| Strain at Yield MD | % | 8.07 | 8.07 | 0.10 |
| Stress at Yield MD | psi | 1834.89 | 2007.64 | −8.60 |

As shown in Table 1, the pellets of Example 1 had a lower Yellowness Index than Examples 3-5. Thus, the pellets comprising upgraded PCR PE made by the method of Example 1 exhibited less discoloration than the pellets comprising upgraded PCR PE made by conventional methods, even though both pellets had the same composition.

Furthermore, as shown in Table 2, the average clarity for Example 1 was higher than the average clarity for Example 3, which further demonstrates that the method of Example 1 causes less cloudiness than conventional methods.

Additionally, as shown in Table 2, the upgraded PCR PE of Example 1 and the upgraded PCR PE of Example 3 shows only minor differences in tensile properties. Thus, it appears that preparing an upgraded PCR PE using the method of Example 1 provides an upgraded PCR PE with similar tensile properties to upgraded PCR PE prepared by conventional methods.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in embodiments, the first component “consists” or “consists essentially of” that second component. It should further be understood that where a first component is described as “comprising” a second component, it is contemplated that, in embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %).

It is also noted that recitations herein of “at least one” component, element, etc., should not be used to create an inference that the alternative use of the articles “a” or “an” should be limited to a single component, element, etc.

1. A process for producing upgraded post-consumer recycled polyethylene (PCR PE) comprising:
melt blending non-pelletized PCR PE with virgin polyethylene in an extruder to produce a PCR/virgin blend, and
melt filtering the PCR/virgin blend to remove contaminants and produce the upgraded PCR PE.

2. The process of claim 1, wherein the virgin polyethylene has a density of 0.870 g/cc to 0.965 g/cc.

3. The process of claim 2, wherein the virgin polyethylene has a density of 0.910 g/cc to 0.930 g/cc.

4. The process of claim 1, wherein the non-pelletized PCR PE comprises post-consumer recycled material derived from monolayer flexible films, multilayer flexible films, and combinations thereof, wherein the monolayer flexible films and the multilayer flexible films have a thickness of less than or equal to 10 mils.

5. The process of claim 1, wherein the non-pelletized PCR PE comprises LDPE having a density of 0.900 g/cc to 0.945 g/cc and a melt index (I₂) of 0.5 g/10 mins to 2.0 g/10 mins.

6. The process of claim 1, wherein there is no additional compounding step downstream of the melt filtering.

7. The process of claim 1, wherein the extruder is a single screw extruder.

8. The process of claim 1, wherein the melt blending involves homogenization of the PCR and the virgin polyethylene.

9. The process of claim 8, wherein the melt filtering occurs downstream of the homogenization.

10. The process of claim 1, wherein the non-pelletized PCR PE and the virgin polyethylene comprise additional additives.

11. The process of claim 1, wherein the melt filtering involves at least two filtration steps.

12. The process of claim 11, wherein the melt filtering involves a first filter having a screen aperture size of 70 to 200 μm, and a second downstream filter having a screen aperture size of 25 to 250 μm, or from 50 to 100 μm.

13. An upgraded PCR PE produced by the process of claim 1.

14. The upgraded PCR PE of claim 13, wherein the upgraded PCR PE has a density of 0.876 g/cc to 0.961 g/cc.

15. The upgraded PCR PE of claim 13, wherein the upgraded PCR PE comprises from 20% to 80% the virgin polyethylene.
